(19) United States
(12) Patent Application Publication
(10) Pub. No.: US 2013/0189648 A1
(43) Pub. Date: Jul. 25, 2013

(54) DEVICE AND METHOD FOR REMOVING DENTAL POSTS

(71) Applicant: C JOHN MUNCE, SANTA BARBARA, CA (US)

(72) Inventor: C JOHN MUNCE, SANTA BARBARA, CA (US)

(21) Appl. No.: 13/748,102

(22) Filed: Jan. 23, 2013

Related U.S. Application Data
(60) Provisional application No. 61/589,733, filed on Jan. 23, 2012.

(51) Int. Cl. A61C 5/08

(52) U.S. Cl. CPC A61C 5/08
USPC 433/221

(57) ABSTRACT

A dental post removal device having a hollow tubular structure having a sidewall and two open ends, and engaging features formed on the sidewall, and a fixing structure formed on the hollow tubular structure adapted for pulling the hollow tubular structure. The engaging features can be a series of openings formed through the sidewall of the hollow tubular structure, and/or the inner wall surfaces of the sidewall that at least one of is scored, textured, dimpled, and/or coated with a high adhesion material. The engaging features being adapted to improve adhesion to a composite resin, cement and/or adhesives to be placed in the hollow tubular structure.

### CROSS-REFERENCE TO RELATED APPLICATIONS

This application claims priority from U.S. Provisional Patent Application No. 61/589,733, filed on Jan. 23, 2012, entitled “Device and Method for Removing Dental Posts.”

### SUMMARY

The invention relates to the field of instruments and methods for dentistry, and more particularly to a device and method for removing dental posts used with dental crowns. In cases where the amount of the tooth's natural crown portion (the part of the tooth that lies above the gum line) is insufficient, it may be necessary to build this area up. Reasons for lost crown include loss due to decay, fracture or being removed during root canal treatment. Dental posts may be metal posts that are cemented inside openings drilled into the tooth and are often used as part of the build up process. The dental post provides a way for the dentist to securely anchor the filling material core to the tooth. After the build up is completed, a dental crown is used to complete the restoration and completely seals off the root.

While dental posts are useful in establishing dental restoration, it may become necessary to later remove the dental post, for example when the dental crown needs replacement or additional procedures need to be performed on the tooth, such as carrying out further endodontic treatment. Since the dental post is often tightly cemented or bonded into a tooth, and may not extend significantly above the gum line, it can be difficult for a practitioner to use forceps or other dental instruments to grasp the post and remove it. Indeed, doing so may place undue stresses and strains on tooth structure into which the post is imbedded and can possibly further damage the tooth. Furthermore, forceps alone may not apply to the post the degree of force or the vector of force required to safely dislodge many posts.

There accordingly remains a need for an improved device and method to remove a metal dental post. The invention provides a dental post removal device and method. The device comprises a tubular structure with a bore with parallel side walls with an internal diameter and an external diameter. For the sake of this description, the tubular structure is described as having an upper open end and a lower open end, where the upper open end describes the end which extends out of the tooth and the lower end describes the end which is inserted into the tooth. Since the tubular device can be used on a maxillary or upper tooth or on a mandibular or lower tooth the terms “upper” and “lower” should not be read to imply “up” and “down” orientations. A series of openings are formed through the sidewalls of the tubular structure. The series of openings are preferably formed at different levels along the long axis of the tubular structure and at various angular positions around the perimeter of the tubular structure, and will act to allow a material such as an auto-polymerizing composite resin, a cement, or other material to be filled into the tubular structure to mechanically connect to the tubular structure so that this material and the dental post received therein will not twist or pull out of the tubular structure. In addition to or in lieu of the series of openings, the inside of the sidewalls can have inward or outward projections, can be scored, textured, indented and/or coated with a high adhesion material that will strongly adhere to the composite resin, cement or other material that will infill the tubular structure's bore. The tubular structure preferably further includes a collar or other fixing structure that extends along the tubular structure and will be positioned for access by a pulling tool. The fixing structure is preferably at or near the upper end of the tubular structure. The fixture structure can be in the nature of a collar that extends outwardly from the sidewalls of the tubular structure, can comprise a bulbous head that extends above the upper end of the tubular structure, can be an indent or groove formed in the sidewall, can be an internally-threaded nut that screws onto threads on the outside of the tube, a screw that screws into an upper end tubular structure, or some other structure or mechanism that is adapted to allow the fixing structure to be securely captured by a removal tool. The fixture structure can be integrally formed with the tubular structure, (e.g., by welding, adhesive, or mechanical attachment, such as being crimped on), or the tubular structure and fixing structure can be formed of a single piece of material, such as by being machined or cast, or it can be attached via threads.

Metallic dental posts come in various lengths and outer diameters, and to accommodate the various dental posts, a series of different sized dental post removal devices with varying lengths and internal diameters of the tubular structure will be provided.

The dental post will have been previously prepared as follows. First, any build up material that was formed around the dental post will be removed, such as by a dental drill or ultrasonic tip. For example, a #1/2 or #1/4 deep dental bur will be used to dissect cement from around the dental post. Once the dental post is free from build up material, then a series of generally horizontal notches or grooves will be formed along different levels and angular positions of the outer sidewall of the dental post. This can be accomplished with a wheel bur, such as offered by Brasseler USA, or other dental instruments. To avoid unduly weakening the integrity of the dental post, such that it might snap off when being removed, the notches should not extend too deeply into the walls of the dental post, and should not completely circumnavigate the dental post. After the dental post is prepared, it should be cleaned and dried. If desired, it may also be coated with an accelerator which can enhance the adhesion of the material such as an auto-polymerizing composite resin, a cement, or other material to the post.

The practitioner will then select the most ideally sized dental post removal device to accommodate the dental post. It may be preferable that the wall structure of the dental post removal device be formed of a deadsoft material so that it can be adjusted (e.g., bent) to easily fit onto the dental post. Before proceeding, the practitioner should trial fit the dental post removal device onto the dental post in order to ensure that it fits well and to ensure that the dental post removal device can be quickly engaged with the dental post once the dental post removal device is charged with composite, cement or other material. An aggressively-fluted endodontic file (such as a hedstrom file) of appropriate length and diameter is then selected, inserted through the open end of the tube, and test-threaded clockwise into the tube, tightly securing itself against the lumen of the tube while becoming engaged into notches on the prepared post. This file is then removed and set aside for later re-insertion. Likewise, the tube of the dental post removal device is also removed in order to prepare it for the next step.

A high strength and fast curing composite resin, cement or other material will be injected (e.g., with a syringe) into the lower opened end of the tubular structure and fill it until the material exits the opposite opened end of the tubular structure. An example of an excellent material for this purpose includes RapidCore® from Centrix®; however, other high strength composite resins or cements for metal to metal adhesion or other materials can be used. If composite is used, it must be an auto-polymerizing type of composite because light-initiated polymerization is ineffective when the material is within the tubular structure of the device. The RapidCore® composite resin will begin to set up immediately and cures in as little as two minutes. Once the composite resin, cement or other material is introduced into the interior of the tubular structure, the tube is quickly fitted over the dental post which has been prepared, and the prior-fitted aggressively-fluted file is immediately re-inserted into the open end of the tube and clockwise rotated to mechanically secure it within the tube alongside the prepared post. The material is allowed to set or polymerize undisturbed. On insertion of the tube onto the post, any material that is forced out through the openings formed in the sidewalls of the tubular structure will not adversely affect the operation of the device. The material will fill in the space in the interior of the tubular structure around the dental post with its grooves or notches formed thereon and adhere to any inward or outward projections, interior scoring, texturing, and/or coating of the sidewalls and lock into the series of any openings formed through the sidewalls of the tubular structure. Thus, the material will effectively permanently lock the dental post together with the tubular structure of the dental post removal device. This will allow a dental post that is tightly cemented or bonded to a tooth, to be safely removed.

After adhesion of the device of the invention to the mechanically-secured file and post, an expansion plier, such as a modified version of a Ruddle Post Remover tool, the Gonon Post remover tool, the Thomas Post remover tool, the Easy X-TRACTOR (A-Titan Instruments), the UPR (Universal Post Remover-Dent Corp), the Outpost (San Diego Swiss Machining) or another similar device, is used to gradually pull outwardly on the dental post removal device and its attached file and dental post. The expansion pliers can be designed to include at its moving end, a catch for engaging the fixing structure of the dental post removal device. To be more effective for removal of threaded posts, this removal device may also be developed in such a way as to apply selectively a rotational force during the extraction process which rotational force may be either clockwise or counter-clockwise and may also be de-selected. Regarding the matter of a rotational force selectively applied during the extraction process, if such rotational force were to be counter-clockwise in order to “unscrew” a clockwise-threaded post, then the hedstrom file should be left-hand fluted so as not to unscrew itself during the counter-rotation of the apparatus during operation. A stationary end of the expansion pliers will be supported on the tooth from which the dental post is being removed. A rubber “insulator” is typically included with the Ruddle device and other similar devices. The insulator provides an interface between the “stationary end” of the Ruddle pliers and the tooth structure on which it will rest when applied.

Another methodology that the inventor uses to off-lay some of the potentially damaging force that can be generated on the cusp tips of compromised tooth structure is as follows. The inventor places a hollow plastic cone over the exposed post, and then injects an auto-polymerizing composite or similar material in the space around the outside of conical tube to fill the cavity space up to the occlusal surface of the tooth and beyond, covering all delicate coronal structure. On polymerization (or setting if not a composite), the plastic cone is removed, and the surface of the material is flattened. This flattened surface provides a robust platform against which to rest that portion of the expansion pliers. The advantage of this over the insulator is that it distributes the considerable force of the pliers throughout the entire coronal structure of the tooth, and not just against the high points of the cusp tips or the perimeter of the cavity preparation as does the rubber insulator. Since the material is not bonded into the tooth, but is only injected passively into the cavity and over the coronal perimeter, after the post is removed, the material is easily removed with dental burs or sometimes with only a simple slight nudge from a hand instrument. The expansion pliers are accordingly used to apply a pulling force to the dental post and remove it from the tooth. The expansion pliers generates considerable mechanical advantage and includes a screw knurl, which when turned, provides the pulling force. Other pulling types of tools can be used with the pulling force being preferably generated along the same axis as the dental post being removed.

As noted above, the dental post removal device can be provided as a series of different tubular structures with parallel side walls having inner and outer diameters to accommodate different sized dental posts. In lieu of providing such a series of different sized tubes, the invention also contemplates providing a dental post removal device with a generally conical-shaped tubular structure with a narrower open end that widens as it progresses upwardly towards either an opened or a closed end. When the wider end is open, it accommodates the insertion of a hedstrom file. The standard hedstrom file has a 02 taper, so providing a slight internal flare of this version of the post removal device—for example a 04 taper-would facilitate a tight adaptation of the 02-tapered file to the flare/taper of the inner wall of the device. With this embodiment, if the dental post is of a larger diameter than the than the open end of the generally conical-shaped tubular structure, the practitioner can cut off a section of the tubular structure so that the open end is large enough to receive the dental post. The end can be cut off with a wheel saw or other commonly available dental instruments. One feature of this embodiment, besides not needing to provide a series of dental post removal devices with different sized tubular structures, is that as a pulling force is exerted on the dental post removal device, the mass of composite, cement or other material formed inside the conical shaped tubular structure around the dental post will be generally frustum conical in shape and will accordingly not be able to pull through the smaller opening.

As a result of using the dental post removal devices and method of the invention, dental posts that are stubbornly affixed in a tooth, even in difficult to access locations, can be reliably removed while minimizing potential stress to the remaining tooth structure to which the dental post is affixed and surrounding teeth and tissue.

### BRIEF DESCRIPTION OF THE DRAWINGS

FIG. 1 is a front view of an exemplary embodiment of a dental post removal device of the invention.

FIG. 2 is a longitudinal cross-sectional view of the dental post removal device of FIG. 1.

FIG. 3 is a detail showing an exemplary embodiment of another dental post removal device of the invention.

FIG. 4 is a detail showing yet another exemplary embodiment of a dental post removal device of the invention.

FIG. 5 is a longitudinal cross-sectional view showing a further exemplary embodiment of a dental post removal device of the invention.

FIG. 6 is a diagrammatic view showing a tooth with a dental post and a dental crown before the dental post is exposed.

FIG. 7 is a diagrammatic view showing a tooth with a dental crown removed and with tooth structure partially removed around the dental post to partially expose the dental post.

FIG. 8 is a diagrammatic view showing the dental post after it is notched.

FIG. 9a is a diagrammatic view showing the notched dental post with a dental post removal device slid on over the dental post, and with dental composite resin, cement or other material filling the space in the dental post removal device around the dental post to secure the dental post removal device and the dental post together, just prior to being removed together from the tooth.

FIG. 9b is a diagrammatic view showing the tooth, post and device of FIG. 9a just prior to the setting of the composite with a hedstrom file inserted through the open end to the point where it has engaged the notched post and thereafter been right-hand rotated with inward pressure so as to fully lodge itself between the post and the wall of the dental post removal device, thus adding significantly to the “adhesion” of the 4-element device (tube, composite, post, and now hedstrom file).

FIG. 10 is a side view of a Ruddle post remover tool used with the dental post removal device of the invention.

### DETAILED DESCRIPTION

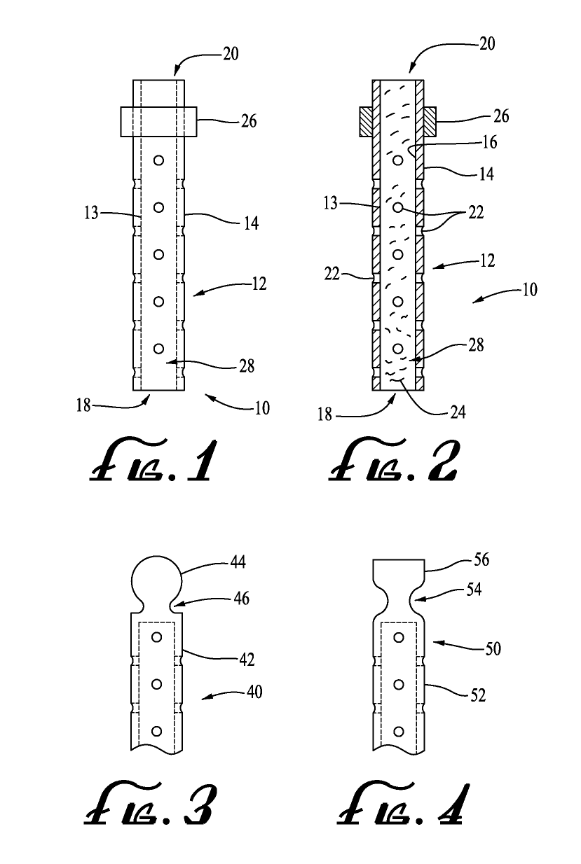

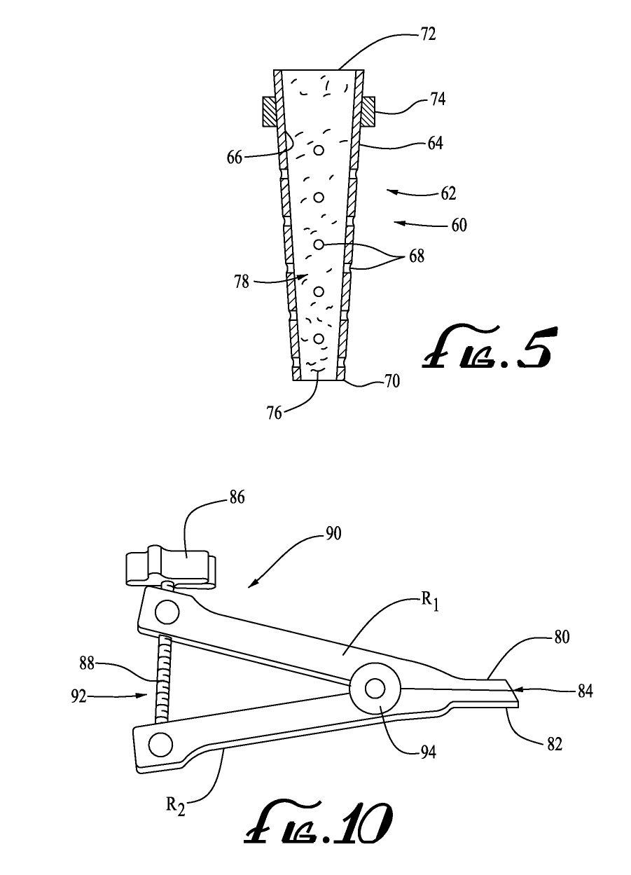

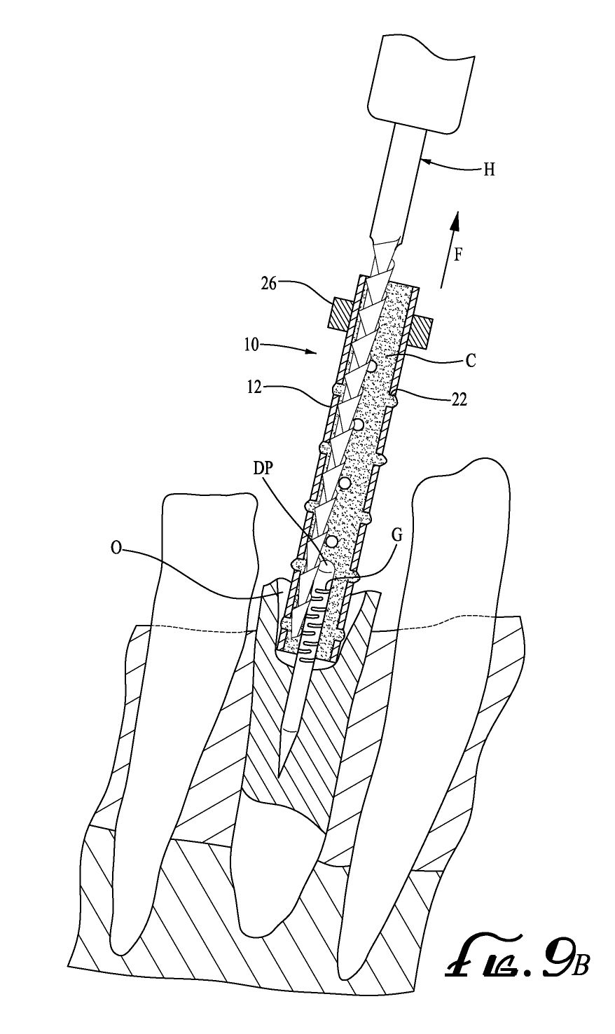

FIG. 1 is a front view of an exemplary embodiment of a dental post removal device 10 of the invention and FIG. 2 is a longitudinal cross-sectional view thereof. The dental post removal device 10 includes a tubular structure 12 with sidewalls 13 with an outer surface 14 and an inner surface 16. The tubular structure 12 has two open ends, 18 and 20 and has a bore 28 running therethrough. A series of through holes or openings 22 are preferably formed through the tubular structure 12. The tubular structure 12 will preferably have sidewalls 13 consist of parallel side walls and will be formed of strong metal. The metal can be non-pliable, or pliable. In addition to metal, the tubular structure can be formed of other materials such as composite materials, such as composites including para-aramid synthetic fiber. The series of openings 22 are preferably at different vertical levels along the long axis of the tube 12 and at different angular positions around the circumference. The series of openings 22 will act to allow composite resin, cement or other material to be filled into the bore 28 of the tubular structure 12 to mechanically connect to the tubular structure 12 so that the composite resin, cement or other material and the dental post received therein (see FIGS. 9a and 9b) will not twist or pull out of the tubular structure 12. In addition to or in lieu of the series of openings 22, the inner surface 16 of the sidewalls 13 can be scored, textured, and/or coated with a high adhesion material 24 that will adhere well to a composite resin, cement or other material. Likewise, rather than including a series of openings formed in the tube or having the inside of the tube scored, textured, and/or coated with a high adhesion material, the tubular structure 12 can have dimples (not shown) formed on the inner surface 16 of the sidewalls 13. These structural features are referred to herein as “engaging features.” The tubular structure 12 further includes a collar or other fixing structure 26 that extends outwardly from the tubular structure and will be positioned for access by a pulling tool. The fixing structure 26 is preferably at or near end 20 of the tubular structure 12. The fixture structure 26 can be in the nature of a collar that extends outwardly from the sidewalls of the tubular structure.

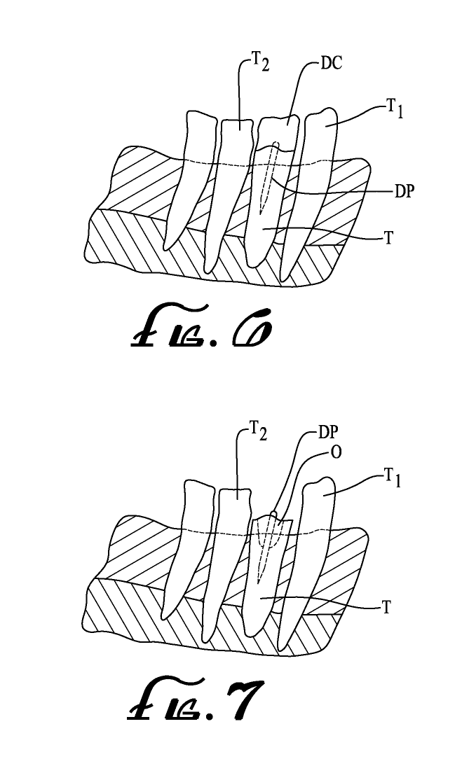

Alternatively, as shown in FIG. 3, a dental post removal device 40 can include as a fixing structure a bulbous head 44 contiguous with a narrower neck 46 that is contiguous on its opposite side with a tubular structure 42; or, as shown in FIG. 4, a dental post removal device 50 can comprise an indent 54 formed in the tubular structure 52 contiguous with a wider end 56 on its opposite side. Other fixing structures that are adapted to allow the fixing structure to be securely captured by a removal tool can also be used, such as indent(s) or groove(s) formed in the sidewall, an internally-threaded nut that screws onto threads on the outside of the tube, a screw that screws into an upper end tubular structure, or some other structure or mechanism that is adapted to allow the fixing structure to be securely captured by a removal tool. The fixture structure can be integrally formed with the tubular structure, (e.g., by welding, adhesive, or mechanical attachment, such as being crimped on), or the tubular structure and fixing structure can be formed of a single piece of material, such as by being machined or cast, or it can be attached via threads. Whatever embodiment of fixture structure used, it can be integrally formed with the tubular structure, (e.g., by welding, adhesive, mechanical attachment such as being crimped on), detachably screwed on, or the tubular structure and fixing structure can be formed of a single piece of material. The tubular structure can, if desired, be formed of deadsoft material that can be formed (e.g. bent) to accommodate the needs of the practitioner. A series of the dental post removal devices 10, 40, 50 can be provided having different gauge tubular structures to best fit different sized dental post to be removed.

FIG. 5 is a longitudinal cross-sectional view showing a further exemplary embodiment of a dental post removal device 60. In lieu of providing a series of different sized tubular structures, the invention also contemplates providing a dental post removal device 60 with a generally conically-shaped tubular structure 62 with a narrower open end 70 that widens as it progresses in its long axis towards the opposite end 72. The conically-shaped tubular structure 62 has an outer surface 64 and an inner surface 66. A series of openings 68 are preferably formed through the conically-shaped tubular structure 62. A collar or other fixing structure 74 that extends outwardly from the tubular structure 62 will be provided for engagement with a pulling tool. The fixing structure 74 is preferably located at or near the wider end 72 of the device 60. Although the tubular structure 62 is shown as having a significant taper, it need only be slightly tapered. The fixture structure 74 can be in the nature of a collar that extends outwardly from the sidewalls of the tubular structure. Alternatively, it can be a bulbous head or an indent formed on the body of the device (similar to FIGS. 3 and 4.) With this particular embodiment dental post removal device 60, if the diameter of the dental post is larger than the open end 70 of the conically-shaped tubular structure 62, the practitioner can cut off a section of the smaller-diameter end of the conical structure 62 so that the newly created open end 70 is large enough to receive the dental post. The end can be cut off with a wheel saw or other commonly available dental instruments. Besides not needing to provide a series of dental post removal devices with different sized tubular structures, this embodiment has an additional benefit. Since the mass of cement formed inside the conically-shaped tubular structure around the dental post will be generally frustum conical in shape, it will not be able to pull through the smaller opening as a pulling force is exerted on the dental post removal device.

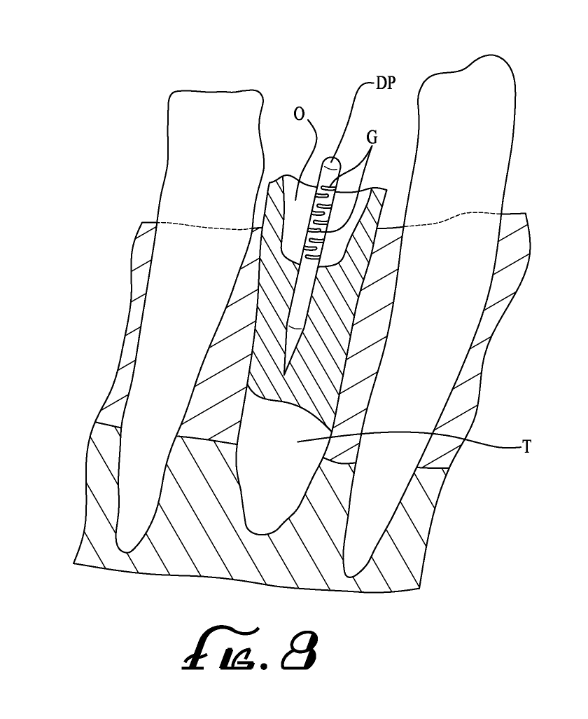

FIG. 6 is a diagrammatic view showing a tooth T with a dental post DP and a dental crown DC before the dental post DP is exposed. As shown, the tooth T is located between two other teeth T₁ and T₂.

FIG. 7 is a diagrammatic view showing a tooth T with a dental crown DC removed and with the tooth structure partially removed to form a cavity O around the dental post P to partially expose the dental post DP. Tooth T is shown between teeth T₁ and T₂.

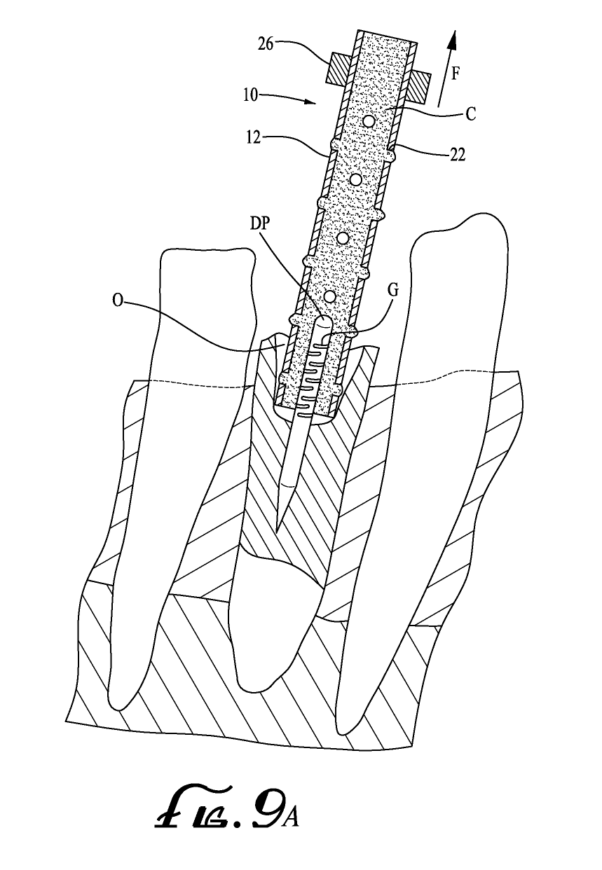

FIG. 8 is a diagrammatic view showing the dental post DP after being prepared by having a series of grooves or notches cut into its sidewalls. The dental post DP will have been previously prepared as follows. First, any build up material that was formed around the dental post DP will be removed, such as by a dental drill or ultrasonic tip, and a cavity O may be formed in the tooth T around the dental post DP if necessary in order to expose the post adequately. For example, a #1/2 or #1/4 Munce Discovery Bur Deep Trougher will be used to dissect cement from around the dental post DP. Once the dental post DP is free from build up material, cement and encroaching tooth structure, then a series of generally horizontal notches or grooves G will be formed along different levels and angular positions around the outer sidewall of the dental post DP. This can be accomplished with a wheel bur, such as offered by Brasseler USA, or other dental instruments. To avoid unduly weakening the integrity of the dental post DP, such that it might snap off when being removed, in cases where the post is of a relatively small diameter, the notches or grooves G should not extend too deeply into the walls of the dental post DP, and preferably nor should the notches be formed all the way around to form a collar groove on the dental post DP. After the dental post DP is prepared, it should be cleaned and dried. If desired, it may also be coated with an accelerator which can enhance the adhesion of the material such as an auto-polymerizing composite resin, a cement, or other material to the post.

The practitioner will then select the most ideally sized dental post removal device to accommodate the dental post DP. It may be preferable that the wall structure of the dental post removal device be formed of a deadsoft material so that it can be adjusted (e.g., bent) to easily fit onto the dental post. Before proceeding, the practitioner should trial fit the dental post removal device onto the dental post in order to ensure that it fits well and to ensure that the dental post removal device can be quickly engaged with the dental post once the dental post removal device is charged with composite resin, cement or other material. While the device remains trial-fitted on the post, a hedstrom file is trial-inserted through the open end to the point where it has engaged the notched post and thereafter been right-hand rotated with inward pressure so as to fully ensure that it will fully lodge itself between the post and the wall of the tube. Once the properly-sized hedstrom file has been selected and trial-inserted as above, the file is removed and set aside.

Next, in order to use the dental post removal device 10, 40, 50, 60 of the invention, a high strength and fast curing composite resin, cement or other material C (see FIG. 9a) will slowly and steadily be injected (e.g., with a syringe) into the one of the open ends 18 or 20 of the tubular structure 12, while withdrawing the injecting end of the syringe from the tube. This is done until the material C has completely filled the tube and has begun to exit the series of openings 22 formed through the sidewalls of the tubular structure 12 and also exits the opposite opened end of the tubular structure 12. Any excess material may be removed before it cures, sets or polymerizes. A good material for this purpose includes RapidCore® composite from Centrix®; however, other high strength composite resins, cements or other materials for metal to metal adhesion can be used. The RapidCore® composite will begin to set up immediately and polymerizes in as little as two minutes. Once the material C is introduced into the interior of the tubular structure 12 and any excess material is removed, the tubular structure 12 is quickly fitted over the dental post DP which has been prepared. The selected hedstrom file is then immediately inserted through the open end of the tube to the level where it begins to engage the prepared post and then right-hand rotated so as to be threaded into the tube fully engaging itself between the post and the wall of the tube. Speed is important here because of the polymerization or setting process of the material which will already be underway. The material inside the device is allowed to polymerize or set undisturbed, affixing each element of the multi-part device into a single unit. Once set or polymerized, any additional material C that has been pushed out of the channel formed in the tubular structure by the dental post DP through the openings 22 formed in the sidewalls of the tubular structure 12, can be removed, if desired, with an instrument, so that it does not extend into cavity O formed in the tooth T around the dental post DP. However, removing these excess “bullets” of material is not really required, but if it does take place, it should only be done after the material completely sets or polymerizes. The composite resin, cement or other material C will fill in the space in the interior of the tubular structure around the dental post DP with its grooves or notches G formed thereon as well as around the flutes on the engaged hedstrom file and adhere to any interior scoring, texturing, and/coating of the sidewalls, or other engaging features (e.g., internal dimples) of the tubular structure, and lock into the series of openings 22 formed through the sidewalls of the tubular structure. Thus, the material C will effectively permanently lock the dental post DP and the hedstrom file together with the tubular structure 12 of the dental post removal device 10. This will allow a dental post DP that is tightly cemented or bonded in place in a tooth to be safely removed.

FIG. 9a is a diagrammatic view showing the notched dental post DP with a dental post removal device 10 slid on over the dental post DP and with dental composite resin, cement or other material C filling the space in the dental post remover tool around the dental post DP and extending into the openings 22 formed in the sidewalls of the dental post removal device 10 to secure the dental post remover tool and the dental post DP together, just prior to being removed together from the tooth.

FIG. 9b is a diagrammatic view showing the tooth, post and device of FIG. 9a just prior to the setting of the composite with a hedstrom file H inserted through the open end to the point where it has engaged the notched post and thereafter been right-hand rotated with inward pressure so as to fully lodge itself between the post and the wall of the tube, thus adding significantly to the “adhesion” of the 4-element device (tube, composite, post, and now hedstrom file).

FIG. 10 is a side view of a Ruddle post remover tool 90 used with the dental post remover tool of the invention. The Ruddle post remover tool 90 has a dental post removal tool engaging lever portion R₁ and a tooth engaging lever portion R₂. The dental post removal tool engaging lever portion R₁ has a dental post removal tool engaging end 80 and the tooth engaging lever portion R₂ has a tooth contact end 82 at a distal end 84 of the device. A knurl 86 is positioned on a threaded shaft 88 near a proximal end 92 of the device which passes through the dental post removal tool engaging lever portion R₁ and the tooth engaging lever portion R₂. By rotating the knurl 86 in a clockwise direction this brings the two proximal ends closer and moves the two distal ends apart from each other. The dental post removal tool engaging lever portion R₁ and the tooth engaging lever portion R₂ are pivoted together by a pivot 94 that is closer to the distal end 84 than the proximal end 92, and can accordingly generate considerable mechanical advantage. After adhesion is established, an extraction tool, such as a modified version of a Ruddle post remover tool, is used to gradually pull outwardly on the dental post removal device and its attached dental post. The Ruddle post remover tool can be modified to include at its moving end a catch for engaging the fixing structures 26, 44, 54, 74 of the dental post removal devices 10, 40, 50, 60, respectively. The distal end of the Ruddle post remover tool's tooth engaging lever portion R₂ will be supported on the tooth T from which the dental post DP is being removed and the distal end of dental post removal tool engaging lever portion R₁ will be engaged with the fixing structure 26, 44, 54, 74 of the dental post removal device 10, 40, 50, 60, respectively. By rotating the knurl 86 in a clockwise direction, a force F will pivot the dental post removal tool engaging end 80, causing it to pull its attached dental post DP out of the tooth T. In practice, once the adhesion between the dental post DP and the tooth T to which it is affixed is broken, the dental post DP can be easily withdrawn.

Although embodiments of the present invention have been described in detail hereinabove in connection with certain exemplary embodiments, it should be understood that the invention is not limited to the disclosed exemplary embodiments, but, on the contrary is intended to cover various modifications and/or equivalent arrangements included within the spirit and scope of the present invention.

What is claimed is:

1. A dental post removal device, comprising:
a hollow tubular structure having a sidewall and two open ends, and engaging features formed on the sidewall; and
a fixing structure formed on the hollow tubular structure adapted for pulling the hollow tubular structure.

2. The dental post removal device of claim 1, wherein the engaging features comprise at least one of a plurality of openings formed through the sidewall of the hollow tubular structure, and the inner wall surfaces of the sidewall are at least one of scored, textured, dimpled, and/or coated with a high adhesion material, the engaging features being adapted to improve adhesion to a composite resin, cement and/or adhesives to be placed in the hollow tubular structure.

3. The dental post removal device of claim 1, wherein the fixing structure comprises a collar on the tubular structure near one of the open ends of the hollow tubular structure.

4. The dental post removal device of claim 3, wherein the collar is permanently attached to the sidewall of the hollow tubular structure.

5. The dental post removal device of claim 1, wherein the hollow tubular structure is selected from the group of materials consisting of pliable metal, non-pliable metal, and/or composite materials.

6. The dental post removal device of claim 1, wherein the tubular structure is of generally constant diameter.

7. The dental post removal device of claim 1, wherein the tubular structure widens from its narrower first open end, to a wider second open end.

8. A dental post removal kit, comprising a series of dental post removal devices, each device comprising:
a hollow tubular structure having a sidewall and two open ends, and engaging features formed on the sidewall; and
a fixing structure formed on the tubular structure adapted for pulling the hollow tubular structure;
wherein in the dental post removal kit, the plurality of hollow tubular structures will have a range of internal diameters.

9. The dental post removal kit of claim 8, wherein the engaging features comprise at least one of a plurality of openings formed through the sidewall of the hollow tubular structure, and the inner wall surfaces of the sidewall are at least one of scored, textured, dimpled, and/or coated with a high adhesion material, the engaging features being adapted to improve adhesion to a composite resin, cement and/or adhesives to be placed in the hollow tubular structure.

10. A dental post removal kit of claim 8, further comprising at least one of composite resin, cement, and/or adhesive.

11. The dental post removal kit of claim 8, wherein the fixing structure comprises a collar on the tubular structure near one of the open ends of the hollow tubular structure.

12. The dental post removal device of claim 11, wherein the collar is permanently attached to the sidewall of the hollow tubular structure.

13. The dental post removal device of claim 8, wherein the hollow tubular structure is selected from the group of materials consisting of pliable metal, non-pliable metal, and/or composite materials.

14. The dental post removal device of claim 8, wherein each dental post removal device in the series of devices has its tubular structure of generally constant diameter.

15. A method for removing a dental post from a tooth, comprising:
preparing a tooth with a dental post by removing material around the dental post;
forming a series of grooves or notches on the dental post;
providing a dental post removal device of claim 1 that is sized to fit over a dental post;
filling the hollow tubular structure of the dental post removal device with dental composite resin, cement, and/or adhesive;
placing the material-filled tubular structure of the dental post removal device over the dental post and immediately insert a fluted file through the open end of the material-filled tubular structure and fully engage flutes of the file between the prepared post and the wall of the tubular device and then allowing the material to polymerize, set or cure to secure the tubular structure, the file and dental post together; and
applying an outward force on the dental post removal device to remove it and its attached file and dental post from the tooth.
